(19) United States
(12) Patent Application Publication
(10) Pub. No.: US 2023/0061459 A1
(43) Pub. Date: Mar. 2, 2023

(54) HOLLOW ROTOR SHAFT

(71) Applicant: Winkelmann Powertrain Components GmbH & Co. KG, Ahlen (DE)

(72) Inventors: Bernd RUDERT, Ahlen (DE); Jens WEGENER, Havixbeck (DE); Ralf GRUENEWALD, Drensteinfurt (DE); Alexander GOETTMANN, Drensteinfurt (DE)

(73) Assignee: Winkelmann Powertrain Components GmbH & Co. KG, Ahlen (DE)

(21) Appl. No.: 17/798,986

(22) PCT Filed: Feb. 10, 2021
(86) PCT No.: PCT/EP2021/053184

§ 371 Date: Aug. 11, 2022

(30) Foreign Application Priority Data
Feb. 14, 2020 (DE) 10 2020 103 875.5

(51) Int. Cl. H02K 1/32; H02K 7/00

(52) U.S. Cl. CPC H02K 1/32; H02K 7/003

(57) ABSTRACT

A hollow rotor shaft for an electric machine rotor rotating about a longitudinal axis includes: a cylinder shell surrounding a shaft cavity; and end flanges on both shell ends transitioning into respective shaft journals. One end flange has an inlet for leading a cooling medium into the cavity and onto the shell inner surface. Inside the cavity, guides distribute cooling medium entering via the inlet over the inner surface, the shell having at least one cooling-medium outlet opening. The shaft is formed in one piece from a tubular initial body. The guides are raised contours formed from the inner surface and protruding into the cavity. The shaft is flow formed by pressing the raised contour out of the inner surface. The end flanges with respective shaft journals are formed by pressing the two initial body ends. The at least one cooling-medium outlet opening is formed in the raised contour.

The invention relates to a hollow rotor shaft for a rotor, rotating around a longitudinal axis, of an electric machine, with a cylindrical shell, which surrounds a shaft cavity, as well as end flanges disposed on the cylindrical shell at both ends, wherein each end flange transitions respectively into a shaft journal and wherein an inlet is provided in one of the end flanges, especially in its shaft journal, via which inlet a cooling medium can be guided into the shaft cavity and onto an inside surface of the cylindrical shell, wherein cooling-medium guiding elements are provided inside the shaft cavity, which elements distribute the cooling medium entering via the inlet over the inside surface of the cylindrical shell, wherein at least one cooling-medium outlet opening is provided in the cylindrical shell, wherein the hollow rotor shaft is formed in one piece by forming from a tubular starting body, wherein the cooling-medium guiding elements are formed as a raised contour formed from the inside surface of the cylindrical shell and protruding into the shaft cavity.

Rotors for electric machines having a hollow rotor shaft and, disposed thereon, metal sheets that are assembled, for example as laminations, are known. These rotors are used, for example, in asynchronous machines or in permanently excited synchronous machines. Electric machines become very hot during operation, e.g. due to the electromagnetic activity in the rotor. A heating of the electric machine leads to a reduction of the efficiency. In order to increase the power of an electric machine and in particular to optimize its efficiency, cooling systems are integrated. For this purpose, different concepts of cooling systems are known, especially for liquid cooling.

A hollow rotor shaft having the features of the preamble of claim 1 is known from DE 10 2016 202 416 A1. This hollow rotor shaft has structural elements that are not intended as cooling-medium guiding elements but due to their geometry fulfill a certain cooling-medium guiding function, even though they serve in principle for interlocking receiving of complementary structural elements of a cooling body. The slot-like regions of the structural elements are therefore largely filled and it is even almost impossible for cooling medium to flow through the regions of the structural elements. An additional cooling body inserted in the hollow rotor shaft is provided for cooling.

A further hollow rotor shaft is known from DE 10 2015 223 631 B4. This built hollow rotor shaft for a rotor, rotating around a longitudinal axis, of an electric machine, has a cylindrical shell, which surrounds a shaft cavity, as well as end flanges disposed on the cylindrical shell at both ends, wherein a shaft journal is situated respectively on the end flanges and wherein an inlet is provided in one of the end flanges, especially in its shaft journal, via which inlet a cooling medium can be guided into the shaft cavity and onto an inside surface of the cylindrical shell, wherein, inside the shaft cavity, a symmetrically shaped cooling-medium distributing element joined with the rotor is disposed perpendicular to the longitudinal axis, which element receives the cooling medium entering via the inlet over a receiving region, guides it via a diverting region in the direction of the inside surface of the cylindrical shell and discharges it onto the inside surface via a discharge region. This known hollow rotor shaft therefore consists of several individual parts to be joined with one another, thus making the manufacture and above all the assembly complex.

The task of the invention is to create a hollow rotor shaft that can be manufactured and assembled with little complexity and in which the cooling capacity can be optimized.

This task is accomplished according to the invention in a hollow rotor shaft of the type designated in the introduction, in that it is formed by means of flow forming, wherein the raised contour is pressed out from the inside surface of the cylindrical shell, wherein the two end flanges are formed with respective shaft journals by pressing the two ends of the starting body, and in that the at least one cooling-medium outlet opening is formed in the raised contour.

Thus a one-piece hollow rotor shaft is made available that is manufactured from a tubular starting body by flow forming and pressing. Due to the one-piece nature, no additional assembly steps are necessary. Moreover, a greater stiffness of the hollow rotor shaft is achieved by the forming processes. Moreover, the cooling capacity is improved, because the cooling medium flows directly along the inside wall of the hollow rotor shaft due to the cooling-medium guiding elements. In this context, it is ensured particularly advantageously by the arrangement of the at least one cooling-medium outlet opening in the raised contour that the cooling medium automatically exits from the shaft cavity when the associated channel-like region is filled, so that a defined quantity of cooling medium flows through the hollow rotor shaft. Thereby the cooling capacity can be methodically adjusted.

In this context, it is preferably provided that the raised contour forms several channel-like regions distributed circumferentially on the inside surface of the cylindrical shell. The raised regions are accordingly ridge-shaped.

In a preferred configuration, it is provided that the channel-like regions are formed helically and/or linearly at least in parts. The inner mandrel of the pressing die can then be screwed out and/or pulled out. Antiparallel helical channel-like regions may also be provided, wherein a multi-part inner mandrel is then used, the individual parts of which are screwed out in different directions of rotation. Alternatively, different, e.g. cam-like contours may also be chosen, in which case an expanding mandrel may be necessary.

It is particularly advantageous when the at least one cooling-medium outlet opening is formed in the raised contour. The cooling medium then exits automatically from the shaft cavity when the associated channel-like region is filled and otherwise would overflow, so to speak.

The invention also relates to a rotor having a hollow rotor shaft as described in the foregoing equipped with laminations.

The invention will be explained in more detail in the following by way of example on the basis of the drawings. These show in

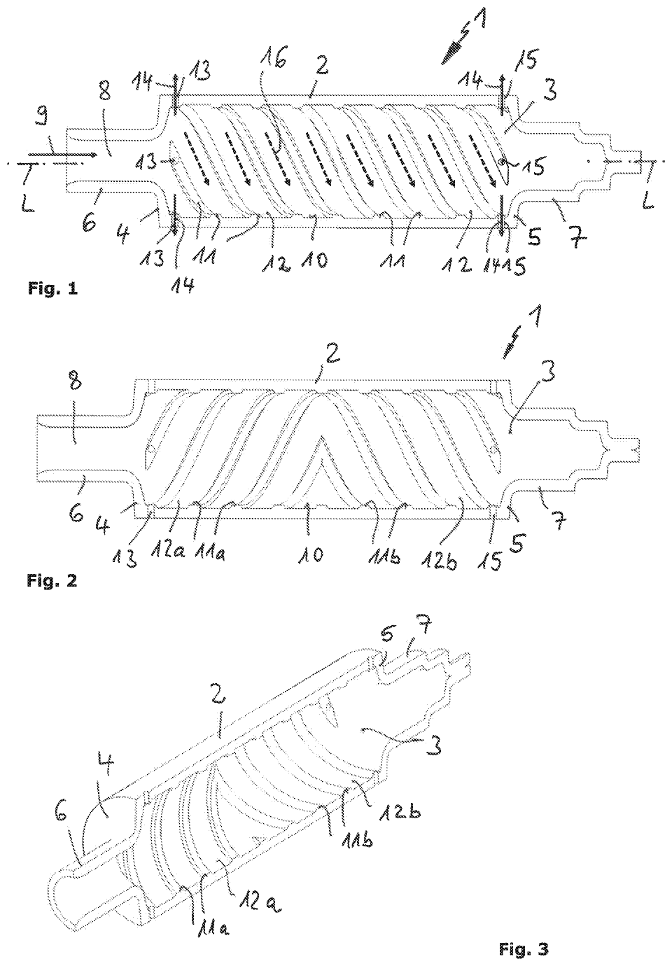

FIG. 1 a section through a hollow rotor shaft according to a first configuration,

FIG. 2 a section through a hollow rotor shaft according to a second configuration,

FIG. 3 a perspective sectional diagram of the hollow rotor shaft according to FIG. 2,

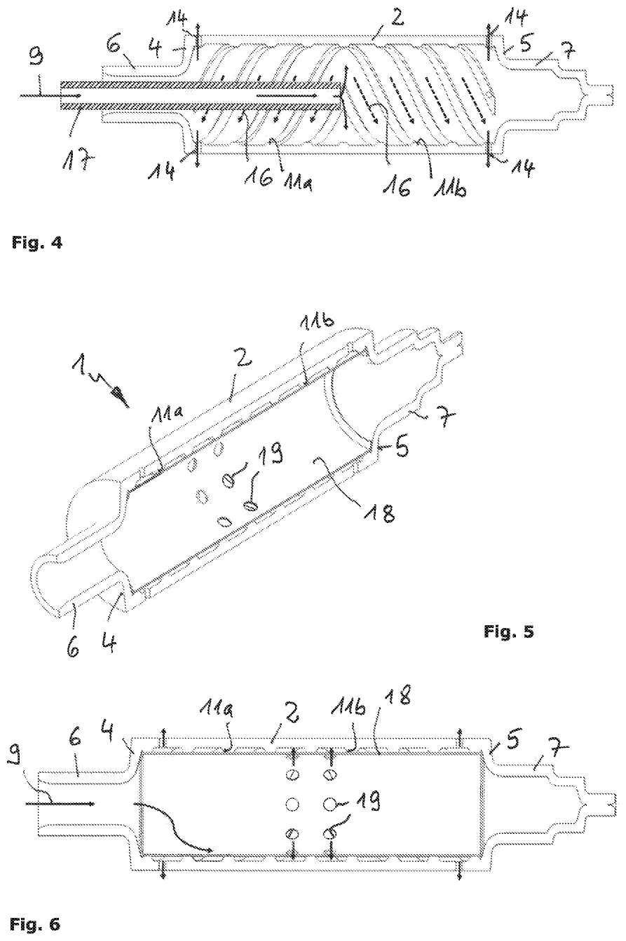

FIG. 4 the hollow rotor shaft according to FIGS. 2 and 3 in slightly modified configuration,

FIG. 5 a hollow rotor shaft in a third configuration in a perspective section,

FIG. 6 the hollow rotor shaft according to FIG. 5 in section,

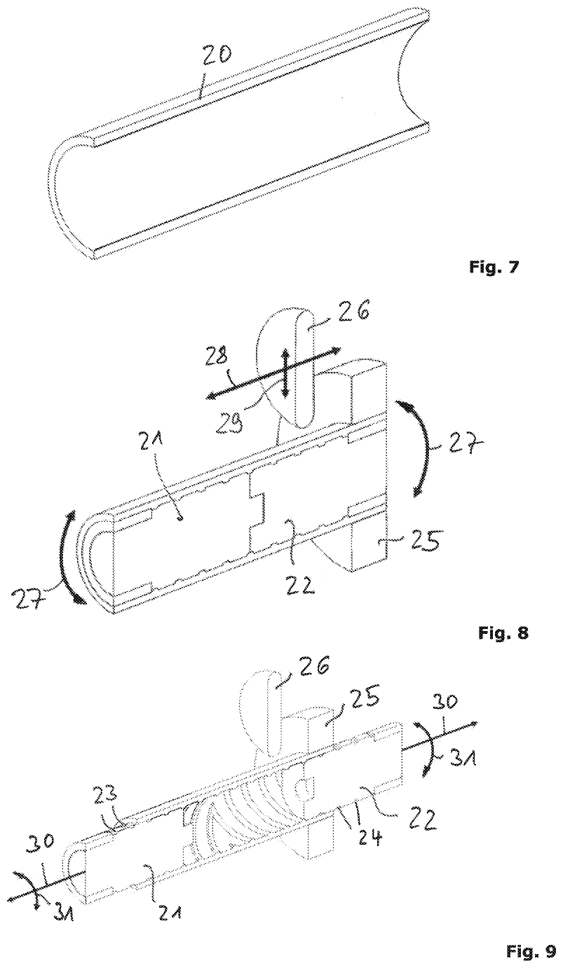

FIG. 7 a perspective diagram of a tubular starting body in longitudinal section,

FIG. 8 a perspective diagram during the flow forming of the starting body,

FIG. 9 a perspective diagram during the removal of a two-part inner mandrel,

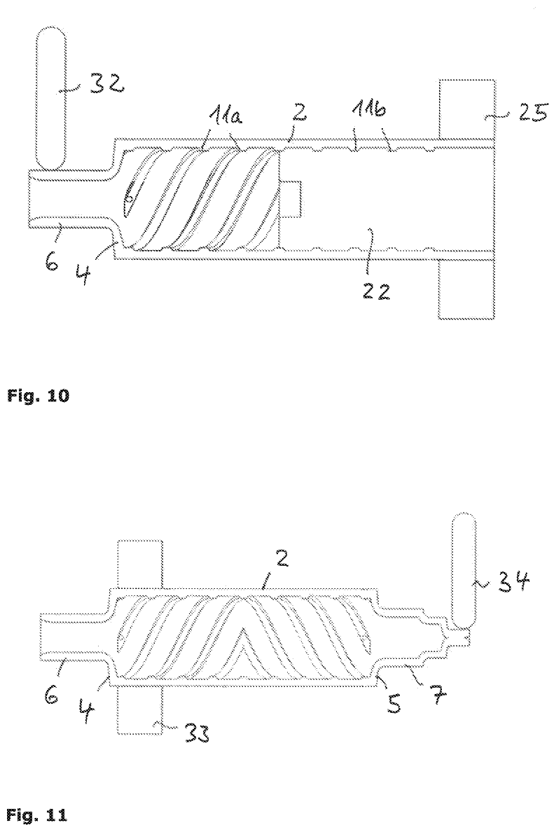

FIG. 10 a sectional diagram during the molding-on of the first end flange together with shaft journal and

FIG. 11 a section during the molding-on of the second end flange together with shaft journal.

A hollow rotor shaft for a rotor, not illustrated, rotating around a longitudinal axis L, of an electric machine is generally denoted by 1. This hollow rotor shaft 1 has a cylindrical shell 2, which surrounds a shaft cavity 3. At both ends of the cylindrical shell 2 of the hollow rotor shaft 1, end flanges are respectively molded on in one piece, namely a first end flange 4 and a second end flange 5. Each end flange 4, 5 transitions into a shaft journal, namely a first shaft journal 6 and a second shaft journal 7. In the first shaft journal 6, an inlet 8 is provided that leads into the shaft cavity 3 and serves for supplying a cooling medium in the direction of the arrow 9.

When the hollow rotor shaft 1 is turning around the longitudinal axis L, the cooling medium passes due to the centrifugal force along an inside surface 10 of the shaft cavity 3, wherein cooling-medium guiding elements are provided for uniform distribution of the cooling medium over the entire inside surface 10 of the shaft cavity 3. These cooling-medium guiding elements are formed as a raised contour pressed out of the inside surface 10 and protruding into the shaft cavity 3, which contour, in the exemplary embodiment according to FIG. 1, is formed by helical ridges 11, which extend along the entire length of the shaft cavity 3. The raised contour formed by these helical ridges 11 thus forms several channel-like regions 12 distributed circumferentially on the inside surface 10 of the cylindrical shell 2, which regions are likewise helical due to the geometry of the ridges 11 in the exemplary embodiment according to FIG. 1.

In the cylindrical shell 2, cooling-medium outlet openings 13 and 15 are provided in the raised contour respectively at the beginning and at the end of the shaft cavity 3, i.e. in the helical ridges 11, through which outlets the cooling medium exits radially outwardly from the shaft cavity 3 in the region of the laminations, not illustrated, of the rotor. This is indicated by arrows 14. The cooling medium is introduced first in the direction of the arrow 9 into the shaft cavity 3 and passes due to the helical channel-like regions 12 and the centrifugal force in the direction of the dashed arrows 16 substantially over the entire area of the inside surface 10 of the cylindrical shell 2, thus cooling this and the surrounding laminations.

A modified embodiment of the hollow rotor shaft 1 is illustrated in FIGS. 2 and 3. This is distinguished from the embodiment according to FIG. 1 only in that the raised contour and the channel-like regions formed thereby are differently configured. Thus antiparallel helical ridges 11a, 11b and correspondingly antiparallel helical channel-like regions 12a, 12b are formed, which respectively transition into one another in the middle of the longitudinal extent of the shaft cavity 3.

The configuration of the hollow rotor shaft 1 according to FIG. 4 differs from that according to FIGS. 2 and 3 in that a cooling-medium supply tube 17 engaging as far as the middle of the shaft cavity 3 is additionally inserted into the first shaft journal 6. Thereby the flow pattern indicated by the arrows 9 and 14 and 16 is obtained.

A further exemplary embodiment of a hollow rotor shaft 1, which corresponds in basic construction to that according to FIGS. 2 and 3, is illustrated in FIGS. 5 and 6. In this case, a further tubular cooling-medium guiding element 18, which in the exemplary embodiment has cooling-medium passage openings 19 in the middle region, is inserted in the shaft cavity 3. The outside of the cooling-medium guiding element bears on the ridges 11a and 11b. In these exemplary embodiments, the cooling-medium outlet openings are formed in the channel-like regions 12a, 15.

A workflow for the manufacture of a one-piece hollow rotor shaft 1 according to FIGS. 2 and 3 is illustrated in FIGS. 7 to 11.

In FIG. 7, a tubular starting body 20 is illustrated that is formed by flow forming and pressing as described in the following in the hollow rotor shaft 1 according to FIGS. 2 and 3.

The tubular starting body 20 is disposed on a two part inner mandrel 21, 22, wherein the inner mandrels 21 and 22 respectively have a negatively raised contour, which is indicated in FIG. 9. For this purpose the inner mandrel 21 has helical depressions 23 complementary to the ridge 11a to be formed and the inner mandrel 22 has helical depressions 24 complementary to the ridge 11b. The tubular starting body 20 is clamped by means of at least one clamping tool 25 and is set in rotation relative to at least one pressing roll 26, as indicated by an arrow 27. This pressing roll 26 can be displaced both in longitudinal direction (arrow 28) and in radial direction (arrow 29) and travels in flow-forming relationship along the tubular starting body 20, whereby the ridges 11a and 11b are formed in the shaft cavity 3 to be formed of the hollow rotor shaft 1 to be formed.

After completion of the flow forming, both inner mandrels 21, 22 can be screwed out of the tubular starting body 20, as indicated by arrows 30 and double arrows 31 in FIG. 9.

Then the first end flange 4 together with the first shaft journal 6 is molded on by pressing from outside with a further pressing roll 32, wherein, as illustrated in FIG. 10, the inner mandrel 22 can still remain inside the shaft cavity 3 during this pressing process. Alternatively, the inner mandrel 22 can also be removed already and the hollow rotor shaft 1 to be formed can be held in appropriate manner. The first shaft journal 6 can also be formed in several stages.

After formation of the first end flange 4 together with the first shaft journal 6, the hollow rotor shaft 1 already finished to this extent is held with a further clamping tool 33 and, if not already done, the second inner mandrel 22 is removed and then the second end flange 5 together with the second shaft journal 7 is formed by pressing from outside with a further pressing roll 34. This shaft journal 7 can also be formed in several stages.

If a further cooling-medium guiding element 18 according to FIGS. 5 and 6 is to be inserted into the hollow rotor shaft 1, this obviously takes place before the second end flange 5 together with second shaft journal 7 is formed.

The workflow for the manufacture of a hollow rotor shaft according to FIG. 1 is in principle the same, but a one-piece inner mandrel may be used that preferably is removed only after the forming of the first end flange 4 together with the first shaft journal 6.

Naturally the invention is not limited to the illustrated exemplary embodiments. Further configurations are possible without departing from the basic idea. Thus the ridges 11, 11a, 11b may also have different contours.

### LIST OF REFERENCE SYMBOLS

1 Hollow rotor shaft
2 Cylindrical shell
3 Shaft cavity
4, 5 End flange
6, 7 Shaft journal
8 Inlet
9, 14, 16, 27, 28, 29, 30 Arrow
10 Inside surface
11, 11a, 11b Ridge
12, 12a, 12b Channel-like region
13, 15 Cooling-medium outlet opening
17 Cooling-medium supply tube
18 Cooling-medium guiding element
19 Cooling-medium passage opening
20 Starting body
21, 22 Inner mandrel
23, 24 Depression
25, 33 Clamping tool
26, 32, 34 Pressing roll
31 Double arrow
L Longitudinal axis

1. A hollow rotor shaft for a rotor, rotating around a longitudinal axis, of an electric machine, with a cylindrical shell (2), which surrounds a shaft cavity (3), as well as end flanges (4, 5) disposed on the cylindrical shell (2) at both ends, wherein each end flange (4, 5) transitions respectively into a shaft journal (6, 7) and wherein an inlet (8) is provided in one of the end flanges (4), especially in its shaft journal (6), via which inlet a cooling medium can be guided into the shaft cavity (3) and onto an inside surface (10) of the cylindrical shell (2), wherein cooling-medium guiding elements are provided inside the shaft cavity (3), which elements distribute the cooling medium entering via the inlet (8) over the inside surface (10) of the cylindrical shell (2), wherein at least one cooling-medium outlet opening (13, 15) is provided in the cylindrical shell (2), wherein the hollow rotor shaft (1) is formed in one piece by forming from a tubular starting body (20), wherein the cooling-medium guiding elements are formed as a raised contour (11, 11a, 11b) formed from the inside surface (10) of the cylindrical shell (2) and protruding into the shaft cavity (3),
wherein
this is formed by means of flow forming, wherein the raised contour (11, 11a, 11b) is pressed out from the inside surface (10) of the cylindrical shell (2), wherein the two end flanges (4, 5) are formed together with respective shaft journals (6, 7) by pressing the two ends of the starting body (20), and in that the at least one cooling-medium outlet opening (13, 15) is formed in the raised contour (11, 11a, 11b).

2. The hollow rotor shaft according to claim 1,
wherein
the raised contour (11, 11a, 11b) forms several channel-like regions (12, 12a, 12b) distributed circumferentially on the inside surface (10) of the cylindrical shell (2).

3. The hollow rotor shaft according to claim 2,
wherein
the channel-like regions (12, 12a, 12b) are formed helically and/or linearly at least in parts.

4. The hollow rotor shaft according to claim 1,
wherein
a further tubular cooling-medium guiding element (18) is inserted into the shaft cavity (3).

5. A rotor having the hollow rotor shaft (1) according to claim 1, equipped with laminations.
